(19) United States
(12) Patent Application Publication
(10) Pub. No.: US 2001/0037265 A1
(43) Pub. Date: Nov. 1, 2001

(54) Method and apparatus for on-line retailing of insurance goods and services

(76) Inventor: Hershel Alan Kleinberg, Alexandria, VA (US)

Correspondence Address: Hershel A. Kleinberg, 5240 Brawner Place, Alexandria, VA, 22304, US

(21) Appl. No.: 09/804,254

(22) Filed: Mar. 13, 2001

Related U.S. Application Data
(60) Provisional application No. 60/189,031, filed on Mar. 14, 2000.

(51) Int. Cl. G06F 17/60

(52) U.S. Cl. 705/27

(57) ABSTRACT

A method and system for selling insurance on-line, particularly where there is an affiliate involved in the transaction who may receive a fee. Available products are determined based on what products the affiliate may sell, what products the user can buy and what products meet the criteria specified by the user. In addition, the affiliate is credited with the user registration and sale and is allotted a fee or commission based on what is allowed by insurance regulations.

### CROSS-REFERENCE TO RELATED APPLICATIONS

This non-provisional application is claiming benefit under 35 U.S.C. 119(e) of U.S. provisional application 60/189,031, “Method And Apparatus For On-Line Retailing Of Insurance Goods And Services.”

### FIELD OF THE INVENTION

The present invention relates generally to computer-based on-line commerce, where a computer user buys goods or services through his computer across a computer network. More particularly, the invention relates to on-line retailing of insurance policies and other services that may be distributed using a system in which commissions and/or administrative fees are generated.

### BACKGROUND OF THE INVENTION

As networks of linked computers become an increasingly more prevalent concept in everyday life, so-called “on-line” interactions between computer users has begun to spread into many different areas of our lives. One of these areas is the marketplace for goods and services.

In the past couple of years there has been an explosive growth in the use of the globally-linked network of computers known as the Internet, and in particular of the World Wide Web (WWW), which is one of the facilities provided on top of the Internet. The WWW comprises many pages or files of information, distributed across many different server computer systems. Information stored on such pages can be, for example, details of a company's organization, contact data, product data and company news. This information can be presented to the user's computer system (“client computer system”) using a combination of text, graphics, audio data and video data. Each page is identified by a Universal Resource Locator (URL). The URL denotes both the server machine, and the particular file or page on that machine. There may be many pages or URLs resident on a single server.

In order to use the WWW, a client computer system runs a piece of software known as a graphical Web browser, such as Internet Explorer (provided as part of the Windows operating system from Microsoft Corporation), or the Navigator program available from Netscape Communications Corporation. “Windows” and Internet Explorer” are trademarks of Microsoft Corporation, while “Navigator” and “Netscape” are trademarks of the Netscape Communications Corporation. The client computer system interacts with the browser to select a particular URL, which in turn causes the browser to send a request for that URL or page to the server identified in the URL. Typically the server responds to the request by retrieving the requested page, and transmitting the data for that page back to the requesting client computer system (the client/server interaction is performed in accordance with the hypertext transport protocol (“HTTP”)). This page is then displayed to the user on the client screen. The client may also cause the server to launch an application, for example to search for WWW pages relating to particular topics.

Most WWW pages are formatted in accordance with a computer program written in a language known as HTML (hypertext mark-up language). This program contains the data to be displayed via the client's graphical browser as well as formatting commands which tell the browser how to display the data. Thus a typical Web page includes text together with embedded formatting commands, referred to as tags, which can be used to control the font size, the font style (for example, whether italic or bold), how to lay-out the text, and so on. A Web browser “parses” the HTML script in order to display the text in accordance with the specified format. HTML tags are also used to indicate how graphics, audio and video are manifested to the user via the client's browser.

A data object known as a “cookie” is often used to track the Web pages visited by a particular user. A “cookie” is a small amount of data which a web site transfers to an Internet browser. Typically, a command line in the HTML of a document tell the browser to set a cookie of a certain name or value. The browser then transfers this information to the hard drive of the person viewing the site. Upon subsequent visits to the transferring site (or other sites), this information can then be retrieved from the hard drive and viewed and modified by the subsequently visited web site. A user's cookie file typically contains a history of the Internet addresses visited. These pathnames are used to signal to the browser which sites placed cookies and will be retrieving them on subsequent visits. The “name=value” pairs under each pathname contain codes which are of use to the web site.

Most Web pages also contain one or more references to other Web pages, which need not be on the same server as the original page. Such references may generally be activated by the user selecting particular locations on the screen, typically by clicking a mouse control button. These references or locations are known as hyperlinks, and are typically flagged by the browser in a particular manner (for example, any text associated with a hyperlink may be in a different color). If a user selects the hyperlink, then the referenced page is retrieved and replaces the currently displayed page.

Hyperlink pages may also be displayed within a web page through a process known as framing which lets web page designers split the browser view into multiple windows, with each window displaying an independent web page. In framed presentations, hyperlinks in one frame can be programmed to update the content of adjacent frames. This makes it possible to launch multiple browser windows and to control the contents of each window through hyperlinks embedded in other windows.

Enterprises (companies) are expanding their usage of the World Wide Web. The first phase, namely the publicity of the company in whatever form, has already occurred. Home pages are commonplace, an essential ingredient for any company that wishes to maintain itself in line with current business practices. The publicity material contains marketing information, product brands and, in some cases, product catalogues.

The second phase, namely to conduct commerce, is emerging. Enterprises are poised to conduct business by way of the World Wide Web. They are seeking to make sales of their products and services, by way of the World Wide Web.

The software infrastructure needed to fully enable this trend is rapidly being perfected. Secure financial protocols have been defined and are being implemented. The provision of firewall technologies offer safeguards to the enterprise, without which the enterprise would not contemplate permitting access to its critical data. Gateway products are becoming available to facilitate connection between the World Wide Web and the server machines of the enterprise.

Many suppliers have begun to sell their goods and services over the World Wide Web by placing their catalogs on their Web pages, such catalogs listing content-related information (e.g., product description, price, availability) about the various goods and services offered for sale. In many cases, businesses are offering goods and services that their customers may be interested in purchasing even though the businesses do not directly sell these goods or services. For example, a travel agency may want to offer travel insurance in order to provide one-stop shopping or comprehensive services to its customers. However, the travel agency may be precluded from selling travel insurance or related insurance products such as international medical insurance by applicable state and federal regulations or simply because it does not want to invest in the infrastructure needed for insurance sales. In other cases, a sales agent or representative may act as an intermediary or middleman, selling a variety of goods and services for a commission or referral fee although the actual transaction is handled by a separate agency or distributorship.

In traditional commercial venues, various systems have been developed to enable an intermediary such as a travel agency or sales agent to refer a customer to an authorized seller in exchange for a commission or referral fee. In web-based commerce these intermediaries are often called affiliates. These systems benefit customers by giving them access to services and service providers they may not have otherwise contacted, sellers by providing them with access to potential customers, and the referring parties by rewarding them for providing a service or referral that otherwise may not have been provided.

However, similar techniques have not yet been developed for electronic commerce using the World Wide Web. Accordingly, certain areas of commerce that traditionally relied upon these systems, such as insurance sales, have been unable to fully participate in electronic commerce in the twenty-first century.

### BRIEF SUMMARY OF THE INVENTION

The present invention provides novel techniques by which commission-based and referral-based affiliate sales can be implemented in web-based commerce. The present invention further provides a novel technique by which the sale of regulated and/or licensed services, such as insurance, may be efficiently and legally conducted over the World Wide Web without endangering the integrity of the regulatory and licensing systems.

In an embodiment of the present invention, a buyer viewing an affiliate Web page initiates an inquiry about a product or service with controlled availability. The availability may be controlled because of government regulations, supplier constraints, implementation restraints, or simply because the distributor limits the sales channel. Irrespective of the reasons for controlled availability, the affiliate providing the initial or referring Web page is unable or unwilling to directly provide information about and/or the requested services. There may also be circumstances in which the referring Web page will appear to be providing the requested services through a process of co-branding, even though the referring Web page only provides access to the requested services through an intermediary.

The initial or referring Web page responds to the customer inquiry using a hyperlink to a next transactional Web page. The transactional Web page may be a single Web page or a plurality of Web pages connected by hyperlink. The transactional Web page may be displayed as a new Web page, entirely replacing the referring Web page in the browser window, or as a framed object, essentially a Web page within the referring Web page. The transactional web page may appear to be from the same web site as the referring web page through co-branding. By using URL parameters, session or application variables, cookies or similar techniques, the transactional Web page and any additional transactional Web Pages can identify the affiliate providing the referring Web page. By using client variables, cookies or similar techniques, subsequent visits to the transactional Web Page can identify the original affiliate. Identification of the affiliate ensures that a referral fee or commission can be accurately computed and properly attributed. In an alternate embodiment, information identifying the affiliate can be entered directly at the transactional web site by the customer or affiliate. Thus an affiliate management area can be provided allowing the affiliates to purchase insurance for customers for those products which they are able to sell.

The transactional Web page provides an interface to a database with information regarding the services or products being sold. In an embodiment of the present invention, the transactional Web page supports a plurality of user queries. The response given to each query may vary depending upon the characteristics of the user (e.g., nationality) and the referring site. It is contemplated that queries may range from specific requests for information, such as how much is this insurance policy for this person under these circumstances, to general requests for comparative or advisory information, such as what medical insurance policies are available for the user, a US citizen, traveling to Asia. The transactional Web page may also provide an interface that supports on-line purchasing of the service or product about which information has been provided, either by direct interface with an electronic commerce server or by linking the customer to a next transactional Web page. In an alternative embodiment of the present invention, the underlying database is associated with a call center allowing customers to make purchases telephonically without unnecessarily repeating the same information.

In one embodiment of the present invention the interface is preferably provided by an Insurance Engine comprised of a database and a database application. In a preferred embodiment of the present invention, the database is an SQL database and the database application is implemented using ColdFusion Application Server from Allaire. The Insurance Engine provides enhanced flexibility, simplifying the implementation of mini-portals and common tools which may be used for a variety of product lines. Thus, for example, a Policy Picker tool that responds to customer description data by identifying the acceptable policies and providing a preferential ranking could be used for either travel insurance, auto insurance, medical insurance, or insurance products aimed at particular markets such as senior products, international products, or business products. Similarly, a Quoting Tool that provides price quotation information may be used for different insurance lines, as could a Product Comparison Tool.

The present invention accordingly broadens the scope of electronic commerce by providing techniques that support commission-based sales and/or the sale of regulated products such as insurance policies.

### BRIEF DESCRIPTION OF THE DRAWINGS

FIG. 1 is a schematic representation of an embodiment of the present invention and the Internet.

FIG. 2 is a schematic representation of an embodiment of the present invention.

FIG. 3 is a schematic representation of a database layout of an embodiment of the present invention.

### DETAILED DESCRIPTION OF THE INVENTION

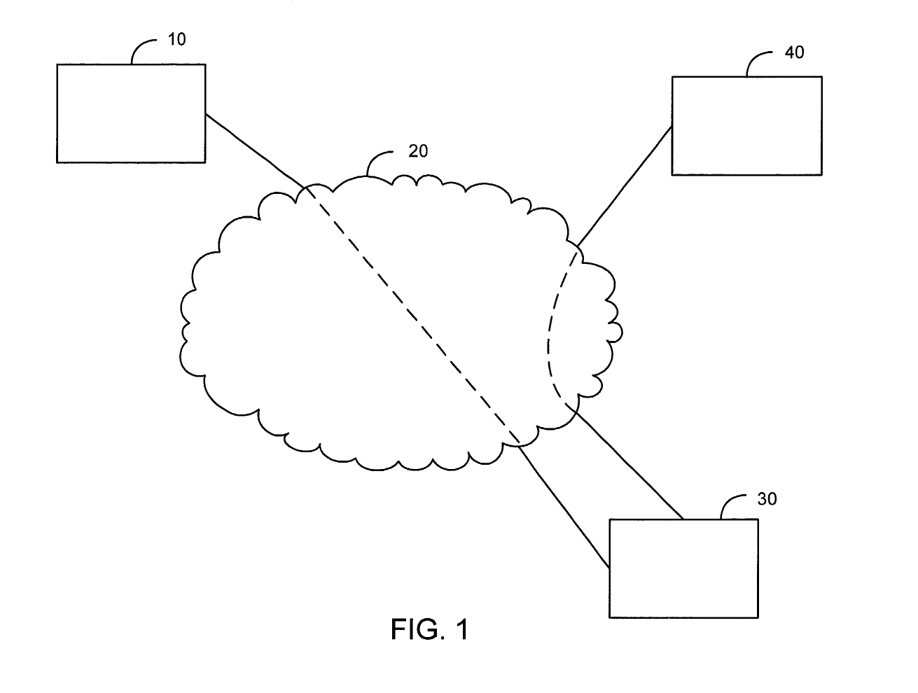

The novel electronic commerce system of the present invention will now be described with reference to the accompanying drawings. Referring to FIG. 1, a customer 10 operating a computer with browser software communicates across the Internet 20 with a web site 30. In a first embodiment of the present invention, web site 30 is a travel agency that provides traditional travel planning and reservation services. These traditional services are provided using techniques known to those of ordinary skill in the art. In addition to traditional services, the operators of web site 30 also offer travel insurance. However, the regulated nature of the insurance industry mandates that sellers of insurance must be individually licensed with different types of insurance products requiring different licenses. Furthermore, insurance companies often limit the types of policies that a particular agent may offer. Accordingly, it is often uneconomical, if not impossible, for a travel agency to directly sell travel insurance, let alone offer a complete or varied range of policy options.

However, web site 30 can offer travel insurance to its customers by incorporating a hyperlink to web site 40 on one or more web pages of web site 30. When a customer activates the hyperlink by, for example, clicking on a button entitled “Travel Insurance,” a page from web site 40 is displayed by the browser software run by customer 10. In one embodiment of the present invention, the page from web site 40 entirely replaces the page from web site 30. In another embodiment of the present invention, the page from web site 40 is framed and appears within a frame as part of web site 30. In either embodiment, the page on web site 30 with a hyperlink to web site 40 is a referring page and the page on web site 40 is a transactional page.

In another embodiment of the present invention, the referring web site may be an authorized insurance agency using the enhanced capabilities of the transactional web pages to increase its product offerings. As discussed below, the underlying database engine of the present invention precludes it from being necessarily restricted to a single line of commerce, although the present invention uniquely addresses barriers to insurance sales across the Internet.

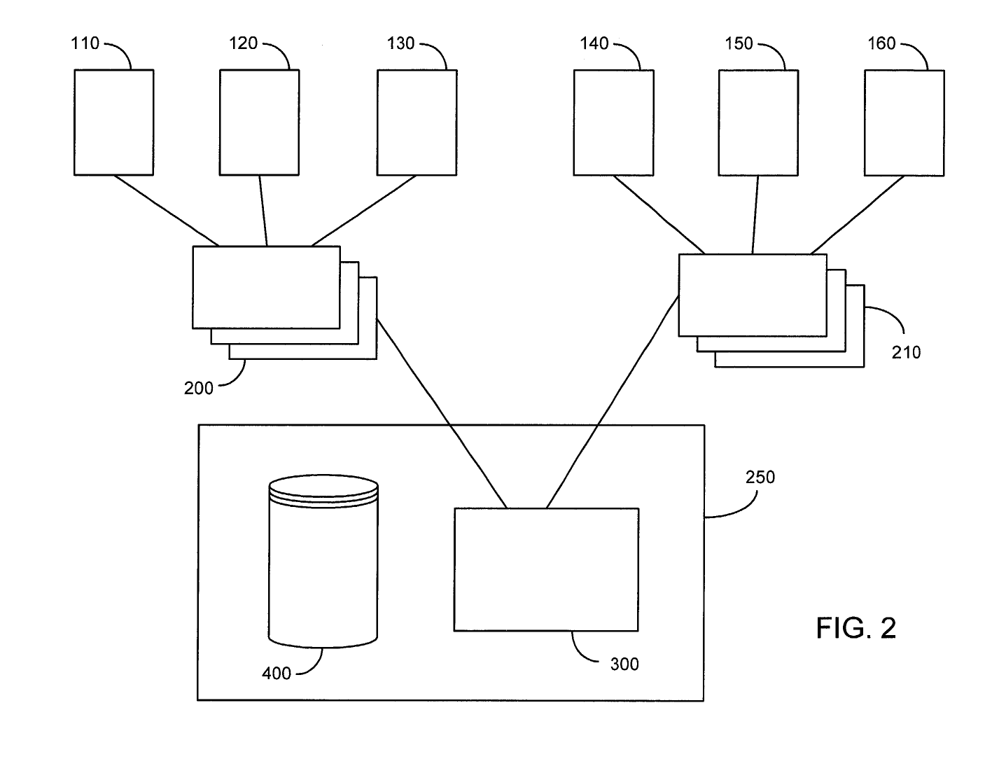

Referring to FIG. 2, a more detailed description of a preferred embodiment is disclosed. Referring web pages 110, 120, and 130 include hyperlinks to transactional web site 200. These referring web pages may reside on a single web site or preferably reside on several different sites. In a preferred embodiment of the present invention, each referring web page 110, 120 or 130 contains a reference code identifying the affiliate and creates a cookie which is referenced by transactional web site 200 when the hyperlink is established by the user to identify the affiliate. Alternately a cookie may be used to uniquely identify the user and information to identify the affiliate is stored in application, session or client variables at transactional web site 200.

By identifying the affiliate providing the referring web page, transactional web site 200 is able to ascertain who should receive a referral fee and/or a commission, if the customer makes a purchase using transactional web site 200. In one embodiment of the present invention, a referral fee and/or commission is only earned for a sale. In an alternative embodiment of the present invention, a referral fee may be earned for each inquiry by a customer, each time a customer registers by providing personal information to transactional web site 200, or simply because a user linked to the transactional web page.

In one aspect of the present invention, transactional web site 200 also generates a cookie the first time a customer visits transactional web site 200. The data in the cookie identifies the affiliate providing the first referring web page 110, 120 or 130, so that a customer who does not make a referral fee or commission generating action until a subsequent visit will still produce a commission or referral fee for the affiliate. By limiting the time period during which the affiliate identification data is valid, the present invention provides a mechanism by which stale or outdated referrals are discarded. Thus, for example, if a customer accesses transactional web site 200 from web page 110 but does not make a purchase (and generate a commission) until two weeks later, affiliate providing referring web page 110 would be credited with the referral and commission obligation. However, if the same customer accesses transactional web site 200 nine months later through a link from referring web page 130, then affiliate providing referring web page 130 will receive the referral credit (nine months is used purely for purposes of example, and the actual time could be shorter or longer or the expiration could be based on events rather than on time).

In one embodiment of the present invention, a referring web page 130 may be co-branded with transactional web site 200. A co-branded web page on transactional web site 200 generally appears to a user as if it is part of or associated with the referring web site. Co-branding may be readily accomplished by, for example, providing special header and footer html code for each co-branded site that replicates or resembles the appearance of the co-branded site. As discussed below, because the operational elements of the present invention are preferably implemented in an insurance engine 250, the aesthetic details of a particular implementation may be readily varied without interfering with operational capability. By providing separate mechanisms for identifying the affiliate providing the presently referring web page and the affiliate providing the originally referring web page, the present invention can provide a co-branded appearance without necessarily giving the co-branded web page affiliate the commission credit. In an alternative embodiment of the present invention, the commission or referral credit may be shared between the original and current referring web page affiliates.

Referring to FIG. 2, transactional web site 200 responds to user queries using Insurance Engine 250. Insurance Engine 250 is comprised of database application 300 and database 400. Database application 300 provides an on-line interface to database 400. In a preferred embodiment of the present invention, database application 300 is a Cold Fusion application interfaced to a SQL database 400. Insurance Engine 250 may include multiple databases and/or multiple applications for multiple types of insurance. Alternatively, a single application may interface to several databases or a single database could include data relating to multiple insurance products (e.g., medical, travel, and automobile). In the embodiment shown in FIG. 2, Insurance Engine 250 comprises a single application 300 interfaced to a single database 400 wherein transactional web sites 200 and 210 separately interface to Insurance Engine 250. Thus, for example, transactional web site 200 could support travel insurance queries from web pages 110, 120, and 130 while transactional web site 210 supports major medical insurance queries from web pages 140, 150, and 160.

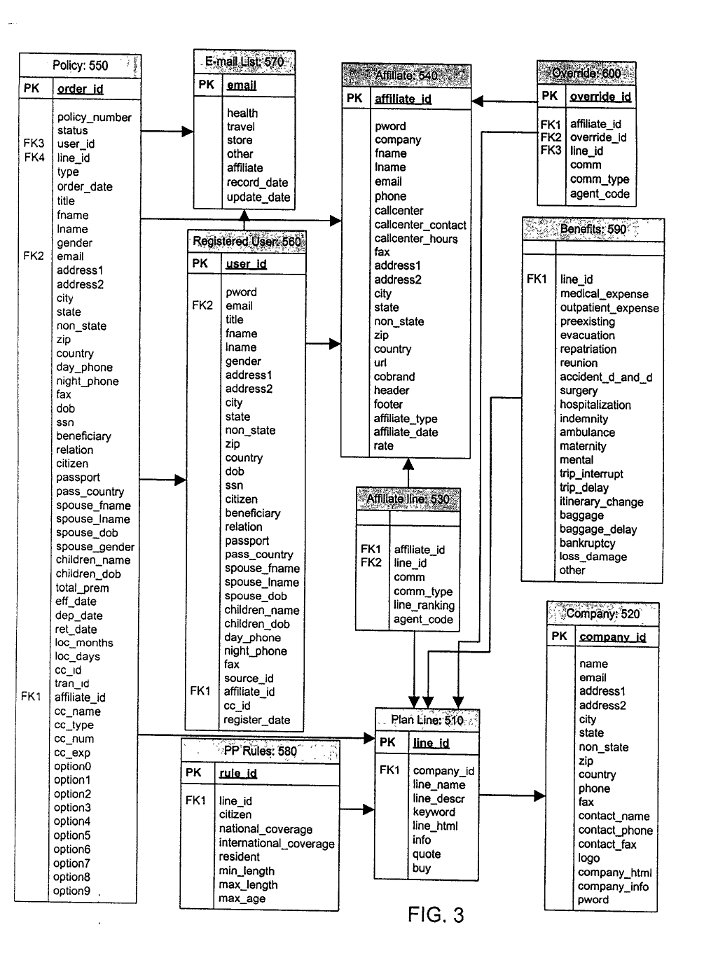

In an embodiment of the present invention supporting travel insurance queries, database 400 may be implemented using ten tables as shown in FIG. 3. Each type of policy is referred to as a line and is identified in plan-line table 510. Each line is associated with a company that provides the insurance line and is linked by a company identifier. The companies providing insurance lines are identified in company table 520. In this embodiment of the present invention, each plan line may have an information web page associated with it which is identified in a line html field. The embodiment of FIG. 3 contemplates that the Insurance Engine may have differing capabilities for different lines and provides for designation of separate quote and buy tools stored in plan-line table 510.

A benefit of the present invention is the ability to provide for commission sales to authorized agents or affiliates. The relationships between the affiliates and the policy lines are implemented in affiliate-line table 530 which identifies the commission type and the amount of commission. A commission may be simply a referral fee generated when a quote request is processed, a new customer is registered or a traditional sale is made. In the embodiment shown in FIG. 3, affiliate-line table 530 also identifies which affiliates are authorized to sell and receive commissions for which lines. The affiliate-line table advantageously provides a technique by which the mix of policies each affiliate is authorized to sell can be easily identified, readily allowing compliance with licensing restrictions, geographic sales restrictions and different company sales allocation policies. Detailed information regarding each affiliate is contained in affiliate table 540. In the embodiment shown in FIG. 3, information regarding co-branding is in affiliate table 540. The affiliate table 540 may also contain rate information for certain referral fees which are not tied to sales such as per quote or per registered customer fees.

In the embodiment of FIG. 3, override table 600 is provided to offer additional levels of commission or referral payment. The override table 600 makes it possible for more then one affiliate to get paid a commission or referral fee from a single sale. In this way a single entity can sign up multiple affiliates and get a commission or referral fee for each of their sales. This is important in the insurance industry to support large agencies as well as national marketing organizations.

Insurance policies are primary elements of any insurance commerce system, and each individual policy is described in policy table 550. The information contained in policy table 550 includes the standard information needed for travel insurance policies as well as information unique to electronic commerce. In an embodiment, information identifying the associated affiliate is also stored in policy table 550 to help effect payment of commissions or referral fees for the sale. Thus, for example, each policy holder is a registered user with information stored in registered user table 560. In an embodiment of the present invention, each buyer must be a registered user before purchasing an insurance policy. Information identifying the affiliate, if any, is stored in user table 560 so that a customer who makes any number of referral fee or commission generating actions, now or in the future, will still produce a commission or referral fee for the affiliate. The embodiment of the present invention advantageously supports call center and on-line sales so the same database may be used for all sales without requiring synchronization or data merging.

In another embodiment of the present invention, a buyer need not be registered before purchasing an insurance policy.

Referring still to the embodiment disclosed in FIG. 3, an e-mail list 570 may also be maintained for marketing and informational purposes. The database structure disclosed in FIG. 3 also supports on-line query tools intended to assist a buyer. A policy picker rules table 580 supports a policy picker tool by identifying the acceptable parameters for the lines in plan-line table 510 and only displaying those lines for which the customer is eligible. Factors including but not limited to customer citizenship, residence, age, destination, and length of trip may be used to determine eligible lines. In an embodiment of the present invention, the information is displayed as short descriptions with links to more comprehensive descriptions, quoting tools, and purchase tools.

Similarly, benefits table 590 supports a comparison tool by which customers can readily compare different plans. In an embodiment of the present invention the plan comparisons are presented in a spreadsheet format, but other presentation formats can be readily accommodated using the underlying database information. As with the policy picker, the information is displayed as short descriptions with links to lengthier or more comprehensive descriptions.

In a preferred embodiment of the present invention, the plans presented by the policy picker tool, by the comparison tool, or by browsing the web site may be limited by the affiliate and/or user characteristics, thus preventing user frustration should, for example, a customer want to purchase a policy unavailable from the affiliate or only available if the customer is not a US citizen. An affiliate may limit the polices available to customers referred by their web site if they want to provide less complex choice to the customer or if they cannot legally receive commission on the sale of the policies. In a preferred embodiment of the present invention, once a customer selects a plan, he may purchase a policy on-line by becoming a registered user. If the user registration information reveals that the user cannot legally purchase the selected policy, an alternative policy is quoted. The user information is validated and a policy is processed, either directly by the selling company or through an intermediary. If a user is not transferred directly to an Insurance Company's system for processing, then the user information is sent to the Insurance Company using encrypted electronic mail. The present invention also supports telephone sales by posting an affiliate identification code on each displayed web page so that the telephone sales agent can request the affiliate identification when processing the sale.

As discussed above, the present invention provides a novel technique for electronic commerce uniquely adapted for insurance sales by transparently accommodating commissioned sales, distribution limitations, licensing and regulatory requirements.

1. A computer implemented method of electronic commerce and information distribution across a computer network comprising the steps of:
providing product information on a first computer-implemented interface;
receiving a query regarding said product information across said computer network;
associating said query with said first computer-implemented interface;
associating said query with user information;
communicating said query to a second computer-implemented interface across said computer network;
storing said user information and said association with said first computer-implemented interface; and
responding to said query.

2. The computer implemented method of claim 1 wherein said first and second computer-implemented interfaces are world wide web pages on one or more world wide web servers and said computer network is the internet.

3. The computer implemented method of claim 2 wherein said step of associating said query with said first computer-implemented interface generates a cookie.

4. The computer implemented method of claim 2 wherein said step of associating said query with user information generates a cookie.

5. The computer implemented method of claim 2 wherein said step of communicating said query to a second computer-implemented interface across said computer network generates a cookie.

6. The computer implemented method of claim 1 wherein said user information includes information sufficient to identify which products the user can legally purchase through said first computer-implemented interface.

7. The computer implemented method of claim 1 wherein said user information includes information sufficient to identify which products the user can legally purchase through said second computer-implemented interface.

8. The computer implemented method of claim 2 wherein first computer-implemented interface is a co-branded world wide web page associated with said second computer-implemented interface.

9. The computer implemented method of claim 2 wherein said step of communicating said query to a second computer-implemented interface across said computer network generates a referral fee.

10. The computer implemented method of claim 2 wherein said step of responding to said query comprises the sub-steps of:
evaluating said user information; and
providing additional product information on said second computer-implemented interface.

11. The computer implemented method of claim 10 wherein said step of responding to said query further comprises the sub-steps of:
determining whether said user has made a previous query within a predetermined time;
identifying the computer-implemented interface from which each said previous query within a predetermined time was communicated; and
determining a referral fee.

12. The computer implemented method of claim 2 wherein said step of responding to said query comprises the sub-steps of:
evaluating said user information;
evaluating said first computer-implemented interface; and
providing additional product information on said second computer-implemented interface wherein said additional product information is based on said evaluation of said user information and said evaluation of said first computer-implemented interface.

13. A computer implemented method for on-line distribution of insurance services information from a transactional web page operably connected to one or more referring web pages, each of said referring web pages being associated with at least one affiliate, comprising the steps of:
receiving a user query communicated from a referring web page to said transactional web page;
receiving information identifying an affiliate associated with said referring web page at said transactional web page;
recording information about said user query, including association of said query with said associated affiliate; and
responding to said user query.

14. The computer implemented method for on-line distribution of insurance services information of claim 13 wherein said step of receiving a user query uses a hyperlink.

15. The computer implemented method for on-line distribution of insurance services information of claim 13 wherein said step of receiving information identifying an affiliate associated with said referring web page at said transactional web page uses a cookie.

16. The computer implemented method for on-line distribution of insurance services information of claim 13 wherein said step of responding to said user query comprises the sub-steps of:
identifying insurance services said user is permitted to purchase;
identifying insurance services said affiliate associated with said referring web page is permitted to offer; and
providing information about insurance services said user is permitted to purchase and said affiliate associated with said referring web page is permitted to offer.

17. The computer implemented method for on-line distribution of insurance services information of claim 16 wherein said step of providing information about insurance services said user is permitted to purchase and said affiliate associated with said referring web page is permitted to offer comprises displaying information about said insurance services on said transactional web page.

18. The computer implemented method for on-line distribution of insurance services information of claim 16 wherein said step of providing information about insurance services said user is permitted to purchase and said affiliate associated with said referring web page is permitted to offer comprises communicating said information about said insurance services to a call center for telephonic communication to said user.

19. The computer implemented method for on-line distribution of insurance services information of claim 16 further comprising the step of registering said user.

20. A system for on-line distribution of insurance services information comprising:
a world wide web page server operably connected to a computer network and a database server, said world wide web page server providing a transactional web page interface capable of receiving a user query communicated from a referring web page associated with an affiliate;
said database server comprising a database application and a database of insurance services, said database application providing an interface between said database of insurance services and said transactional world wide web page;
said database of insurance services further providing database information identifying restrictions on insurance service availability based on an affiliate associated with a referring web page; and
said database of insurance services further providing database information identifying the commission to which said affiliate associated with a referring web page is entitled to receive if said user query results in an insurance service transaction.
